(19) United States
(12) Patent Application Publication
(10) Pub. No.: US 2011/0280481 A1
(43) Pub. Date: Nov. 17, 2011

(54) USER CORRECTION OF ERRORS ARISING IN A TEXTUAL DOCUMENT UNDERGOING OPTICAL CHARACTER RECOGNITION (OCR) PROCESS

(75) Inventors: Bogdan Radakovic, Redmond, WA (US); Milan Vugdelija, Belgrade (RS); Nikola Todic, Seattle, WA (US); Aleksandar Uzelac, Seattle, WA (US); Bodin Dresevic, Bellevue, WA (US)

(73) Assignee: MICROSOFT CORPORATION, Redmond, WA (US)

(21) Appl. No.: 12/780,991

(22) Filed: May 17, 2010

(51) Int. Cl. G06K 9/03; G06K 9/34

(52) U.S. Cl. 382/177; 382/311

(57) ABSTRACT

An electronic model of the image document is created by undergoing an OCR process. The electronic model includes elements (e.g., words, text lines, paragraphs, images) of the image document that have been determined by each of a plurality of sequentially executed stages in the OCR process. The electronic model serves as input information which is supplied to each of the stages by a previous stage that processed the image document. A graphical user interface is presented to the user so that the user can provide user input data correcting a mischaracterized item appearing in the document. Based on the user input data, the processing stage which produced the initial error that gave rise to the mischaracterized item corrects the initial error. Stages of the OCR process subsequent to this stage then correct any consequential errors arising in their respective stages as a result of the initial error.

### BACKGROUND

Optical character recognition (OCR) is a computer-based translation of an image of text into digital form as machine-editable text, generally in a standard encoding scheme. This process eliminates the need to manually type the document into the computer system. A number of different problems can arise due to poor image quality, imperfections caused by the scanning process, and the like. For example, a conventional OCR engine may be coupled to a flatbed scanner which scans a page of text. Because the page is placed flush against a scanning face of the scanner, an image generated by the scanner typically exhibits even contrast and illumination, reduced skew and distortion, and high resolution. Thus, the OCR engine can easily translate the text in the image into the machine-editable text. However, when the image is of a lesser quality with regard to contrast, illumination, skew, etc., performance of the OCR engine may be degraded and the processing time may be increased due to more complex processing of the image. This may be the case, for instance, when the image is obtained from a book or when it is generated by an image-based scanner, because in these cases the text/picture is scanned from a distance, from varying orientations, and in varying illumination. Even if the performance of scanning process is good, the performance of the OCR engine may be degraded when a relatively low quality page of text is being scanned. Accordingly, many individual processing steps are typically required to perform OCR with relatively high quality.

Despite improvements in OCR processes errors may still arise such as misrecognized words or characters, misidentification of paragraphs, textual lines or other aspects of page layout, for instance. At the completion of the various processing stages the user may be given an opportunity to identify and correct errors that arise during the OCR process. The user typically has to manually correct each and every error, even if one of the errors propagated through the OCR process and caused a number of the other errors. The manual correction of each individual error can be a time consuming and tedious process on the part of the user.

### SUMMARY

A user is given an opportunity to make corrections to the input document after it has undergone the OCR process. Such corrections may include misrecognized characters or words, misaligned columns, misrecognized text or image regions and the like. The OCR process generally proceeds in a number of stages that process the input document in a sequential or pipeline fashion. After the user corrects the misrecognized or mischaracterized item (e.g., mischaracterized text), the processing stage responsible for the mischaracterization corrects the underlying error (e.g., a word bounding box that is too large) that caused the mischaracterization. Thereafter, each subsequent processing stage in the OCR process attempts to correct any consequential errors in its respective stage which were caused by the initial error. Of course, processing stages prior to the one in which the initial error arose have nothing to correct. In this way the correction of errors propagates through the OCR processing pipeline. That is, every stage following the stage in which the initial error arose recalculates its output either incrementally or completely, since its input has been corrected in a previous stage. As a result the user is not required to correct each and every item in the document that has been mischaracterized during the OCR process.

In one implementation, an electronic model of the image document is created by undergoing an OCR process. The electronic model includes elements (e.g., words, text lines, paragraphs, images) of the image document that have been determined by each of a plurality of sequentially executed stages in the OCR process. The electronic model serves as input information which is supplied to each of the stages by a previous stage that processed the image document. A graphical user interface is presented to the user so that the user can provide user input data correcting a mischaracterized item appearing in the document. Based on the user input data, the processing stage which produced the initial error that gave rise to the mischaracterized item corrects the initial error. Stages of the OCR process subsequent to this stage then correct any consequential errors arising in their respective stages as a result of the initial error.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows one illustrative example of a system for performing optical character recognition (OCR) on a textual image.

FIG. 2 is a high-level logical diagram of one particular example of OCR engine 20.

FIG. 3 shows a textual document in which textual regions labeled regions 1-8 have been identified by OCR.

FIG. 4 shows one example of a graphical user interface that may be provided to the user by the error correction component.

FIG. 5 is flowchart illustrating one example of a method for correcting a textual image of a document.

### DETAILED DESCRIPTION

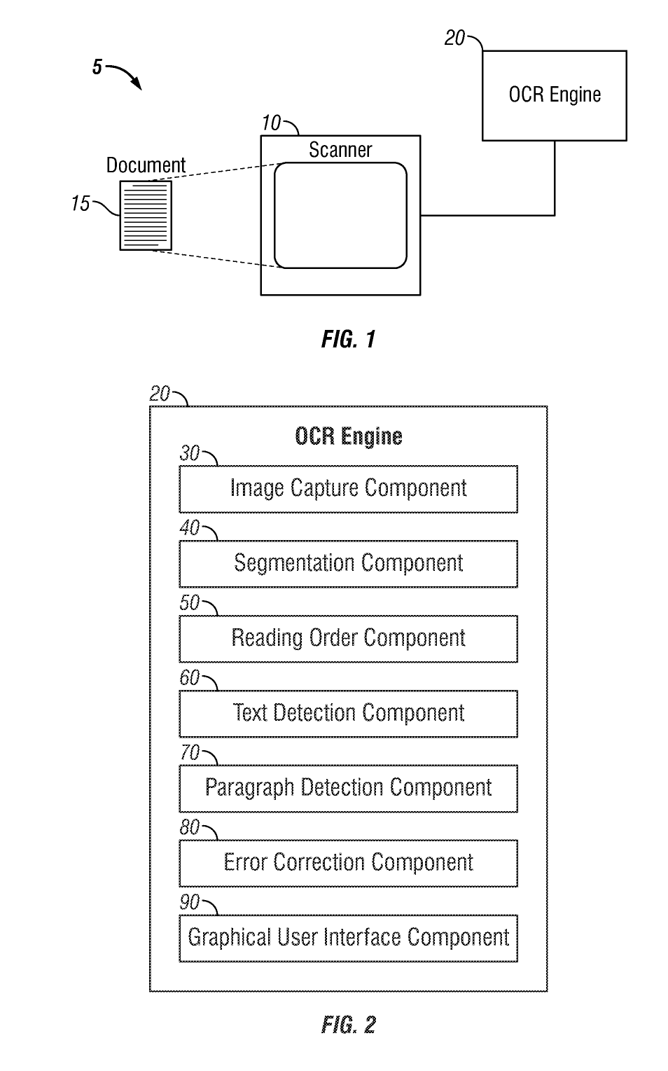

FIG. 1 shows one illustrative example of a system 5 for performing optical character recognition (OCR) on a textual image. The system 5 includes a data capture arrangement (e.g., a scanner 10) that generates an image of a document 15. The scanner 10 may be an image-based scanner which utilizes a charge-coupled device as an image sensor to generate the image. The scanner 10 processes the image to generate input data, and transmits the input data to a processing arrangement (e.g., an OCR engine 20) for character recognition within the image. In this particular example the OCR engine 20 is incorporated into the scanner 10. In other examples, however, the OCR engine 20 may be a separate unit such as stand-alone unit or a unit that is incorporated into another device such as a PC, server, or the like.

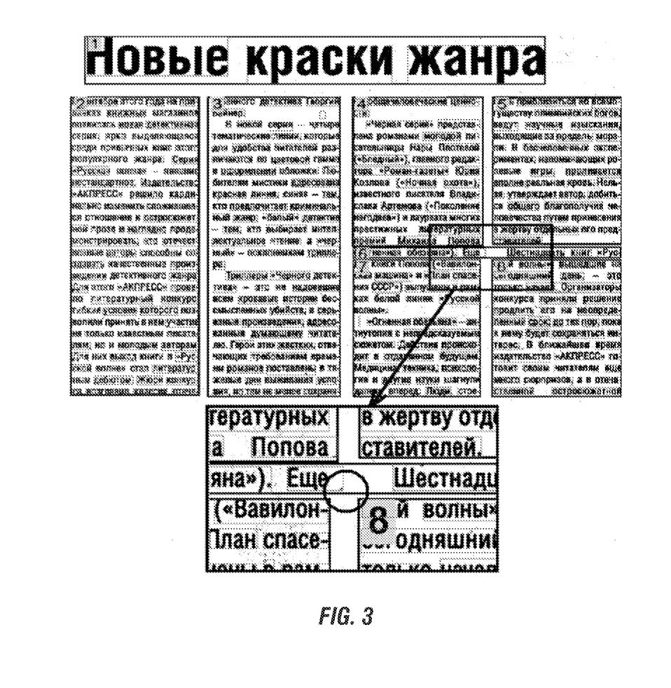

FIG. 2 is a high-level logical diagram of one particular example of OCR engine 20. In this example, the OCR engine is configured as an application having the following components: image capture component 30, segmentation component 40, reading order component 50, text detection component 60, paragraph detection component 70, error correction component 80 and graphical user interface (GUI) component 90. It should be noted however, that FIG. 2 simply represents one abstract logical architecture of an OCR engine with elements that in general may be implemented in hardware, software, firmware, or any combination thereof. Moreover, in other examples of such an architecture the number and/or type of components that are employed may differ, as well as the order in which various textual features are detected and recognized.

The image capture component 30 operates to capture an image by, for example, automatically processing an input placed in a storage folder received from a facsimile machine or scanner. The image capture module 30 can work as an integral part of the OCR engine to capture data from the user's images or it can work as a stand-alone component or module with the user's other document imaging and document management applications. The segmentation component 40 detects text and image regions on the document and, to a first approximation, locates word positions. The reading order component 50 arranges words into textual regions and determines the correct ordering of those regions. The text recognition component 60 recognizes or identifies words that have previously been detected and computes text properties concerning individual words and text lines. The paragraph detection component 70 arranges textual lines which have been identified in the text regions into paragraphs and computes paragraph properties such as whether the paragraph is left, right or center justified. The error correction component 80, described in more detail below, allows the user to correct errors in the document after it has undergone OCR via GUI component 90.

Regardless of the detailed architecture of the OCR engine, the OCR process generally proceeds in a number of stages that process the input document in a sequential or pipeline fashion. For instance, in the example shown in FIG. 2 paragraph detection takes place after text recognition, which takes place after the determination of reading order, which takes place after the segmentation process. Each subsequent component takes as its input the output which is provided by the previous component. As a result, errors that arise in one component can be compounded in subsequent components, leading to yet additional errors.

The input data to each component may be represented as a memory model that is electronically stored. The memory model stores various elements of the document, including, for instance, individual pages, text regions (e.g., columns in a multicolumn text page, image captions), image regions, paragraphs, text lines and words. Each of these elements of the memory model contain attributes such as bounding box coordinates, text (for words), font features, images, and so on. Each component of the OCR engine uses the memory model as its input and provides an output in which the memory model is changed (typically enriched) by, for example, adding new elements or by adding new attributes to currently existing elements.

An initial error that arises in one component of the OCR engine can be multiplied into additional errors in subsequent components in two different ways. First, since the behavior of the OCR process is deterministic, it typically makes the same type of error more than once, generally whenever a problematic pattern is found in the input document. For example, if some very unusual font is used in the document, the character ‘8’ may be recognized as the character ‘s’ and that error will most probably repeat on each appearance of the character ‘8’. Similarly, if a paragraph that is actually a list of items is misrecognized as normal text, the same error may arise with other lists in the document.

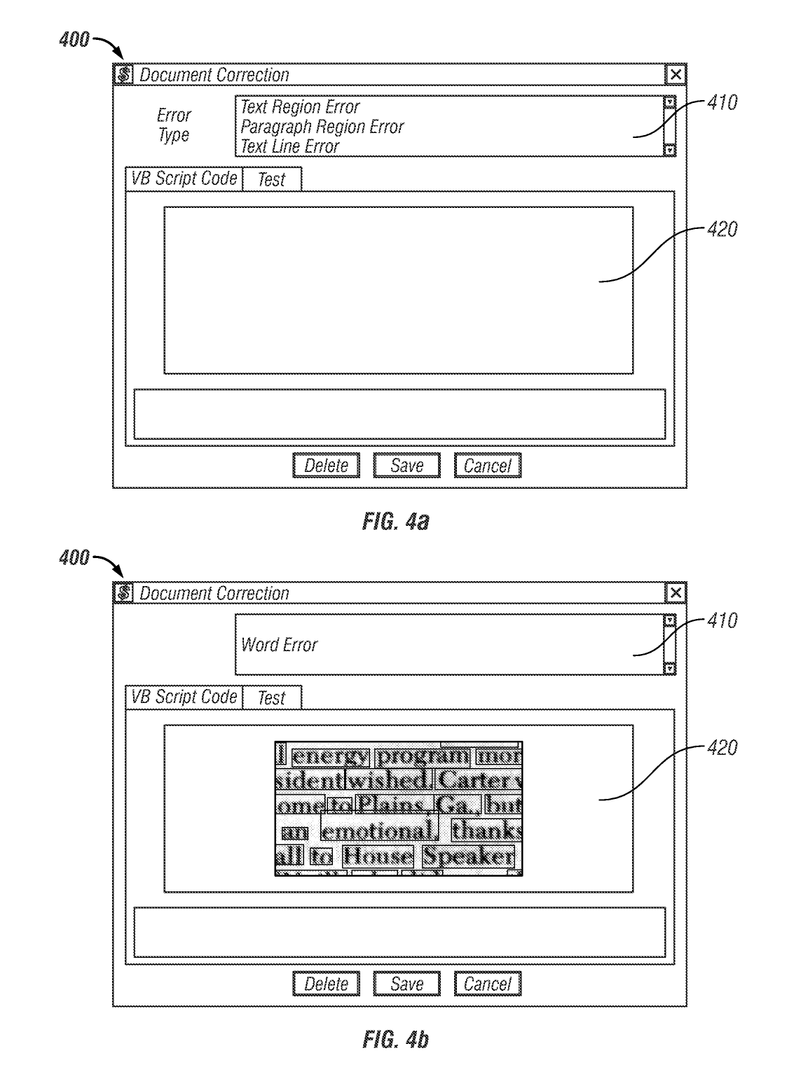

Second, an initial error may be multiplied because a subsequent component relies on incorrect information obtained from a previous component, thereby introducing new errors. An example of this type of error propagation will be illustrated in connection with FIG. 3. FIG. 3 shows a textual document in which textual regions labeled regions 1-8 have been identified by OCR. In this example a small amount of dirt, shown within the circled region of the enlarged portion of the document, was misidentified as text, causing the word bounding box that overlaps with the circle to be too large. Because of this misidentification, the reading order component identified text region 6 as too large in width, extending between the text regions 4 and 7 as well as between 5 and 8. As a consequence five text regions (regions 4-8) were identified when in fact the reader order component should have correctly only identified two text regions, one corresponding to a column defined by region 4, the left half of region 6 and region 7 and the other corresponding to another column defined by region 5, the right half of region 6 and region 8.

The first occurring error, such as the misrecognition of dirt for text in the above example, will be referred to as the initial error. Subsequent errors that arise from the initial error, such as the mischaracterization of the text regions in the above example, will be referred to as consequential errors.

As detailed below, a user is given an opportunity to make corrections to the input document after it has undergone the OCR process. Such corrections may include misrecognized characters or words, misaligned columns, misrecognized text or image regions and the like. Once the processing stage responsible for the mischaracterization (e.g., mischaracterized text) corrects the underlying error (e.g., a word bounding box that is too large) that caused the mischaracterization, each subsequent processing stage attempts to correct any consequential errors in their respective stages which were caused by the initial error. Of course, processing stages prior to the one in which the initial error arose have nothing to correct. In this way the correction of errors propagates through the OCR processing pipeline. That is, every subsequent stage recalculates its output either incrementally or completely, since its input has been corrected in a previous stage. As a result the user is not required to correct each and every item in the document that has been mischaracterized during the OCR process.

It should be noted that the since the user is generally not aware of the underlying error that caused the mischaracterization, the user is not directly correcting the error itself, but only the result of the error, which exhibits itself as a mischaracterized item. Thus, the correction performed by the user simply serves as a hint or suggestion that the OCR engine can use to identify the actual error.

In addition to correcting consequential errors, the stage or component responsible for the initial error attempts to learn from the correction and tries to automatically re-apply the correction where appropriate. For instance, as in the above example, if a user has indicated that the character ‘8’ has been mischaracterized as the character ‘s’ that error has probably occurred for many appearances of the character ‘8’. The responsible component will thus attempt to correct similar instances of this error.

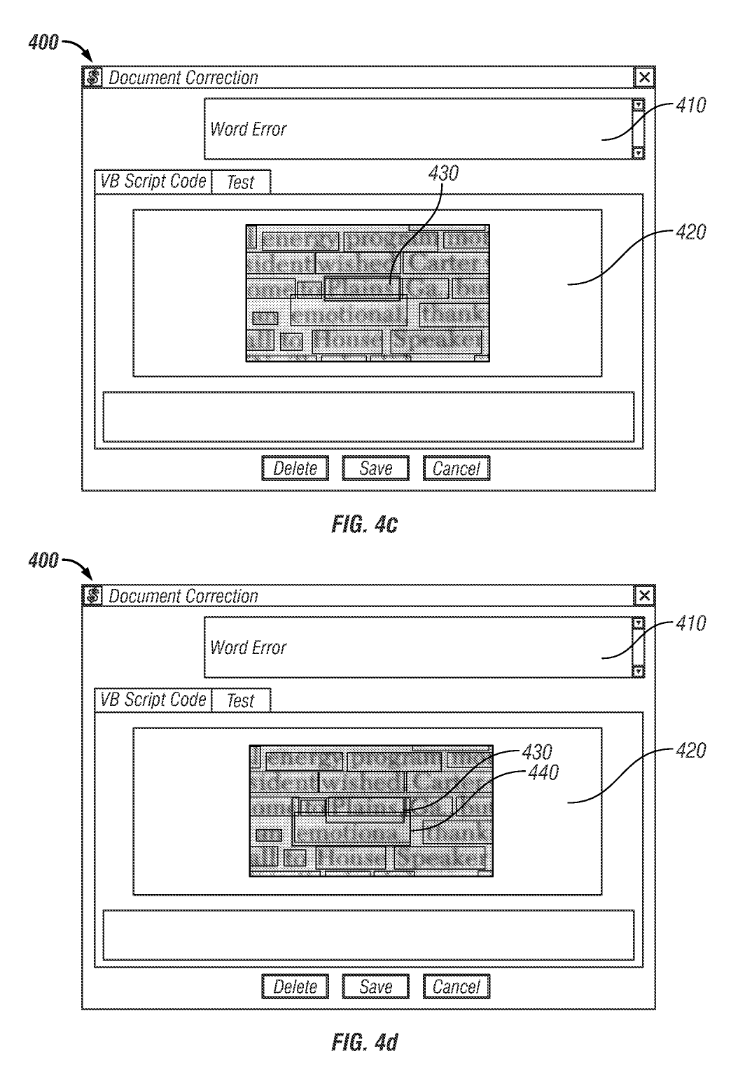

FIG. 4a shows one example of a graphical user interface 400 that may be provided to the user by the GUI component 90. Of course, this interface is simply one particular example of such an interface which will be used to illustrate the error correction process that is performed by the various components of the OCR engine. More generally, the user may be provided with any appropriate interface that provides the tools to allow him or her to indicate mischaracterizations that have occurred during the OCR process.

The illustrative GUI 400 shown in FIG. 4 requests two pieces of information from the user in order to implement the correction process. First, the user is requested to define or categorize the error type. This information may be received by the correction component via the GUI in any convenient manner. In the example of the FIG. 4a the user selects from a series of predefined error categories that is provided to the user via pull-down menu 410. Such predefined error categories may include, for example, a text region error, paragraph region error, paragraph end error, text line error, word error, image region error and so on.

A text region error may arise if a large portion of text is completely missed (e.g. due to low contrast), or if identified text is not correctly classified into text regions (e.g., titles, columns, headers, footers, image captions and so on). A paragraph region error may arise if text is not correctly separated into paragraphs. A paragraph end error arises if a paragraph's end is incorrectly detected at the end of text region (typically a column), although it actually continues to the next text region. A text line error arises if a text line is completely missed or if text lines are not separated correctly (e.g., two or more lines are incorrectly merged vertically or horizontally or one line is incorrectly split into two or more lines). A word error arises, for example, if punctuation is missing, if a line is not correctly divided into words (e.g., two or more words are merged together or a single word is divided into two or more words), or if all or part of a word is missing (i.e., not detected). An image region is similar to text region error and may arise if all or part of an image is missing. Other types of errors arises from the incorrect detection of an image or text, which may occur, for example, if content other than text (e.g. dirt, line art) is incorrectly detected as text.

The predefined error type that is selected by the user assists the error correction component in identifying the component of the OCR engine that caused the initial error. However, it should be noted that more than one component may be responsible for a given error type. For instance, a text region error may indicate an initial error in the segmentation component (because e.g., a portion of text was not detected at all or because incorrect word bonding boxes were defined) or in the reading order component (because e.g., the word bounding boxes are correct but the words are not correctly classified into text regions).

The other piece of information provided by the user to implement the correction process is input that corrects the mischaracterized item. One way this user input can be received is illustrated by the GUI in FIG. 4b. In this example the document is presented in a display window 420 of the GUI. The word bounding boxes surrounding each word in the document is also shown for facilitating the user correction process (though in some implementations the user may be able to turn off the bounding boxes so that they are not visible). The category of the error selected by the user is a word error. In this example the comma after the word “plains” was originally missing. The comma had not been included because the OCR engine had mischaracterized it as being part of the word “emotional,” causing that word to have been mischaracterized as “emotionai”. This error occurred because, as seen in FIG. 4b, the bounding box surrounding the word “emotional” mistakenly included the comma after the word “plains”. In this case the user corrects the error by highlighting or otherwise indicating the portion of the appropriate bounding box or boxes that have been incorrectly detected. The error detection component then recognizes the words as shown in FIG. 4b. However, in FIG. 4b the word bounding boxes have not yet been updated to reflect this change. In FIG. 4c the error correction component recognizes a user area 430 (i.e., the area of the textual image on which the user makes corrections) in which the user has re-defined the bounding box surrounding the word “plains”.

The error correction component 80 also defines a zone of interest 440, which includes the user area 430 and all the word bounding boxes that intersect with the user area. The zone of interest 440 is shown in FIG. 4d. In this particular example the word bounding boxes which intersect the user area include the words “to” “plains,” and “emotional”. Based on the error type specified by the user and the words and punctuation that have been re-characterized by the user in the display window, the segmentation component first recalculates the connected components (i.e., the components that make up each character or letter when represented in edge space) within the zone of interest. The segmentation component then analyzes the position of each connected component with respect to the user area and the previously detected word bounding boxes. Connected components are deemed to belong to the user area if more of its pixels are located inside rather than outside the user area. Each connected component found to belong within the user area are associated with a new word or with some previously detected word or line. Any words that now have no connected component associated with them (in this case the original word “plains”) are deleted. The bounding boxes of all the elements (e.g., words) within the zone of interest are then updated since they may have lost some of their connected components or may have received one or more new connected components.

To reiterate, in the example shown in FIGS. 4b-4d, the user area 430 encompasses the text “Plains,” (including the comma) and the zone of interest 440 is expanded beyond the user area 430 to include the word “emotional”, since this is the only word bounding box that intersects with the user area. In this case all the connected components will remain in their original word bounding boxes, except for those in the word “Plains” and the following comma sign, which will all be associated with the new word being defined by the user in the user area. Since the word “emotional” has lost the connected components associated with the comma, its bounding box is reduced in size and designated as unrecognized. In this way the word will be re-recognized by the text recognition component. The new word “plains,” will also be designated as unrecognized so that it too will be re-recognized.

In summary, after the user corrects any mischaracterized items in the user area, the error correction component 80 causes one or more new words to be created, connected components within the zone of interest to be reassigned, bounding boxes to be recomputed and words to be re-recognized.

In addition to using the current user input data shown in FIG. 4, the correction component also takes into account previously received user input that has been provided to correct other mischaracterized items. For instance, if a previous error type was a text region error or a word error and if some words or lines in the current zone of interest were modified during the process of correcting that error, then the criteria that is employed when correcting the current error may be more stringent. For instance, any errors that are now corrected should maintain previous user corrections of mischaracterized items. Such previous user corrections may be maintained or preserved in a number of different ways. In one example, new attributes may be added to the memory model that each component uses as its input data. One new attribute may be a confidence level for the various items elements determined by the components of the OCR engine. The confidence level that is assigned to each element may depend in part on whether the item was determined during the initial OCR process or if it was determined when correcting an initial or subsequent error that was identified when the user corrected a mischaracterized item. For example, the confidence level for a word or character may be set to a maximum value when that word or character is directly entered (either by typing or by selecting from among two or more alternatives) by the user during the correction process.

In the example described above the error category selected by the user was a word error. A similar correction process may be performed for other error categories. If the error category is a text region error, for instance, this type of error may often be easier to correct than a word error because it is less likely to involve problems caused by intersecting bounding boxes. This is because text regions are generally more easily separable than words or lines. If however the error does involve the intersection of word bounding boxes, the connected components may be examined in the manner discussed above. More typically, a more straightforward alternative may be used, which is to simply check whether the user area located in the display window contains the center of any word bounding boxes. If the user area does not contain any word box centers, it can be assumed that there are no words in the region. This implies that the error occurred in the segmentation component since a text region was presumably completely missed. In this case, the word detection algorithm is re-executed, but this time restricted only to the user area, which enables the component to better determine the background and foreground colors. Optionally, the segmentation component may also increase the sensitivity to color contrast when re-executing the word detection component. If on the other hand the user area does contain one or more word bounding boxes without cutting any of them (or alternatively, if the user area contains the center of some word bounding boxes), then the error may be treated as a text region separation error. That is, the words are not properly arranged into regions, which suggests that the problem lies with the reading order component and not the segmentation component. In such a case there is nothing for the segmentation component to correct.

If the predefined error category selected by the user is an image region error, the user input may be received by the GUI in a more complex manner than shown in FIG. 4. For instance, the user may be provided with a lasso tool to define the user area. In this way the user can identify connected components that are incorrectly disposed in an image region.

If the error type selected by the user is a text region error, it is likely that the initial error arose in the reading order component. A primary task of the reading order component is the detection of text regions. This component assumes that word and image bounding boxes are correctly detected. The reading order component executes a text region detection algorithm that generally operates by creating an initial set of small white-space rectangles between words on a line-by-line basis. It then attempts to vertically expand the white-space rectangles without overlapping any word bounding boxes. In this way the white-space rectangles become larger in size and may be merged with other white-space rectangles, thereby forming white-space regions. White-space regions that are too short in height (i.e., below a threshold height) are discarded, as are those that do not contact a sufficient number of text lines on either their left or right borders. The document is then divided into different textual regions, which are separated by the white-space regions that have been identified.

Accordingly, the reading order component will be the first to respond to the error correction component when the error type selected by the user is a text region error and the words in the display window 420 are located either entirely within or outside of the user area. When a text region error is identified by the user, the reading order component modifies its basic text region detection algorithm as follows. First, all word bounding boxes contained in the user area are removed from consideration and all regions previously defined by the user are temporarily removed. Next, the basic text region detection algorithm is executed, after which the newly defined user area is added as another text region. In addition, the regions that were temporarily removed are added back. If a confidence level attribute is employed it may be set to its maximum value for the newly defined region (i.e., the user area).

If the error type selected by the user is a text line error, a procedure analogous to that described above for a text region error is performed.

Learning from User Input

As previously mentioned, the stage or component responsible for an initial error may attempt to learn from the correction and automatically re-apply the correction where appropriate. Other components may also attempt to learn from the initial error. To understand how this can be accomplished, it will be useful to recognize that the various components of the OCR engine make many classification decisions based on one or more features of the document which the components calculate. The classification process may be performed using rule-based or machine learning-based algorithms. Examples of such classification decisions include:
Deciding whether or not a given connected group of dark pixels on a light background, should be classified as text;
Deciding whether or not two given words belong to the same line of text (which may become difficult in the case of subscripts, superscripts and punctuation);
Deciding whether or not a given white-space between portions of text in the same text line is a word break;
Deciding whether or not a given horizontally extending bar of white-space (typically several lines of text high) between two blocks of text are two separate text columns; Identifying a character from a given cleaned bitmap of a connected component;
Deciding whether or not a given line of text denotes the end of a paragraph;
Deciding whether a given paragraph is justified left, right, both, or centered;

Examples of document features that may be examined during the classification process include the size of a group of pixels, the difference in the median foreground/background color intensity and the distance between this group of pixels and its nearest neighboring group. These features may be used to determine whether or not the group of pixels should be associated with text. Some features that may be examined to classify two words as belonging to the same or a different text line include the height of the words, the amount by which they vertically overlap, the vertical distance to the previous line, and so on.

During the correction process the OCR engine concludes that some set of features should have led to a different classification decision. Once these re-classification rules have been determined, they may be used in a number of different ways. For instance, they may only be applied to the current page of a document undergoing OCR. In this case the re-classification rule is applied by searching the page for the pattern or group of features that the re-classification rule employs, and then making a classification decision using the re-classification rule.

In some cases, instead of applying the re-classification rule to each page of a multiple-page document, the rules may be restricted to apply to the current page only. On the other hand, if a multiple-page document is completely processed before any human intervention, the re-classification rules may be applied to other pages of the document. If however the user works in a page-by-page mode in which each page is corrected immediately after that page undergoes OCR processing, the rules may or may not be applied during the initial processing of the following pages, depending perhaps on user preference.

If desired the re-classification rules may be applied to other documents as well as the current document and may even become a permanent part of the OCR process performed by that OCR engine. However, this will generally not be the preferred mode of operation since format and style can vary considerably from document to document. The OCR engine is typically tuned to perform with high accuracy in most cases and thus the re-classification rules will generally be most helpful when a document is encountered with unusual features such as an unusually large spacing between words and punctuation marks (such as in old style orthography), or with an extremely small spacing between text columns In such cases learning from the user input data that corrects mischaracterized items will be helpful within that document, but not in other documents. Therefore, the preferred mode of operation may be to only apply the re-classification rules to the current document only. For instance, this may be the default operating mode and the user may be provided with the option to change the default so that the rules are applied to other documents as well.

As one example of the applicability of a re-classification rule, when the user selects an error type that requires text to be deleted or a word, text line or text region to be properly defined, the segmentation component may determine that a small group of pixels has been mistakenly misclassified as text (such as in the case where dirt is recognized as punctuation). The re-classification rule that arises from this correction process may be applied to the entire document. As another example, a re-classification rule that is developed when an individual character is misrecognized as another character may be applied throughout the document since this is likely to be a systematic error that occurs wherever the same combination of features is found. Likewise, the misclassification of a textual line as being either the end of a paragraph or a continuation line in the middle of a paragraph may occur systematically, especially on short paragraphs with insufficient context. User input to correct an error in how a paragraph is defined (either by not properly separating text or by not detecting a paragraph's end) will typically invoke the creation of a line re-classification rule, which may then be used to correct other paragraphs.

Consequential Error Correction

During the correction of a particular error, the various components of the OCR engine modify the memory model by changing the attributes of existing elements or by adding and removing elements (e.g., words, lines, regions) from the model. Therefore, the input to the components whose processes are executed later in the OCR pipeline will have slightly changed after the error has been corrected earlier in the pipeline. The subsequent components take such changes into account, either by fully re-processing the input data or, when possible, by only re-processing the input data that has changed so that the output is incrementally updated. Typically, stages that are time consuming may work in an incremental manner while components that are fast and/or very sensitive to small changes in input data may fully re-process the data. Thus, some of the components are more amenable to performing an incremental update than other components. For instance, since the segmentation component is the first stage in the pipeline, it does not need to process input data that has been edited in a previous stage.

The reading order component is very sensitive to changes in its input data since small input changes can drastically change its output (e.g. reading order may change when shrinking a single word bounding box by a couple of pixels), which makes it difficult for this component to work incrementally. Fortunately, the reading order component is extremely fast, so it can afford to re-process all the input data whenever it changes. Accordingly, this component will typically be re-executed using the data associated with the current state of the memory model, which contains all previous changes and corrections arising from user input.

After the segmentation process corrects an error using user input, some word bounding boxes may be slightly changed and completely new words may be identified and placed in the memory model. Typically, a very small number of words are affected. Accordingly, the text recognition component only needs to re-recognize those newly identified words. (While some previously recognized words may be moved to different lines and regions when the reading order component makes corrections, these changes do not introduce a need for word re-recognition). Accordingly the text recognition component can work incrementally by searching for words that are flagged or otherwise denoted by a previous component as needing to be re-recognized. This is advantageous since the text recognition process is known to be slow.

Since the reading order component can introduce significant changes in a memory model of a document, it generally will not make much sense for the paragraph detection component to work incrementally. But since the paragraph component is typically extremely fast, it is convenient for it to re-process all the input data whenever there is a change. Therefore, the paragraph component makes corrections by using the user input to correct initial errors arising in this component, the current state of the memory model and information obtained as a result of previous user input (either through the list of all previous actions taken by the user to correct mischaracterizations, or through additional attributes included in the memory model, such as confidence levels).

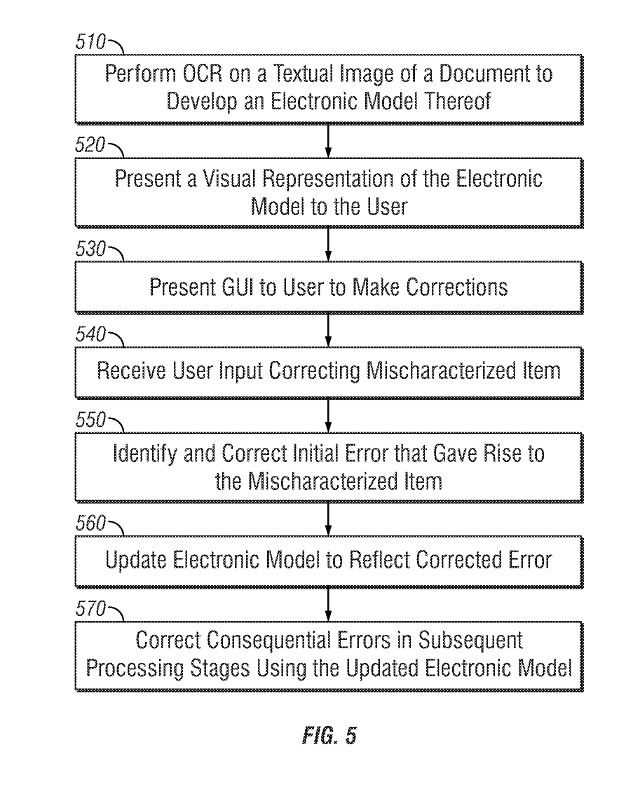

FIG. 5 is flowchart illustrating one example of a method for correcting a textual image of a document. First, in step 510, the document undergoes OCR, during which an electronic model of the image is developed. Next, a visual presentation of the electronic model is presented to the user in step 520 so that the user can identify any mischaracterized items in the text image. A graphical user interface (GUI) is also presented to the user in step 530. The user can use the GUI to correct any of the mischaracterized items of text that are found. In step 540, user input is received via the GUI correcting the mischaracterized item. The initial error or errors that occurred during the OCR process which gave rise to the mischaracterized item is corrected in step 550. The electronic model of the document is updated in step 560 to reflect the initial error or errors that have been corrected. Finally, in step 570, consequential errors are corrected in processing stages subsequent to the one in which the initial error arose using the updated electronic model.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An image processing apparatus for performing optical character recognition, comprising:
an input component for receiving a textual image of a document;
a segmentation component for detecting text and images in the document and identifying word positions;
a reading order component for arranging words into textual regions and arranging the textual regions in a correct reading order;
a text recognition component for recognizing words and computing text properties concerning individual words and textual lines;
a paragraph detection component for arranging textual lines which have been identified in the textual regions into paragraphs;
a user interface through which the user provides user input data, wherein the user input data corrects a first mischaracterized item appearing in the document after undergoing OCR; and
an error correction component for receiving the user input data and causing a first of the components in which an initial error producing the first mischaracterized item arose to correct the initial error, wherein the error correction component is further configured to cause components that process the image subsequent to the first component to correct consequential errors arising as a result of the initial error.

2. The image processing apparatus of claim 1 wherein the first of the components is further configured to automatically correct other errors that give rise to other mischaracterized items of a same type as the first mischaracterized item.

3. The image processing apparatus of claim 1 wherein the user interface includes a menu of preselected error types from which the user selects as part of the user input data.

4. The image processing apparatus of claim 3 wherein the preselected error types include a plurality of error types selected from the group consisting of a text region error, a paragraph region error, a paragraph end error, a text line error, a word error and an image region error.

5. The image processing apparatus of claim 1 wherein the user input includes selection of a first error type and, based at least in part on the first error type, the error correction component causes one or more selected components to be re-executed at least in part to correct the initial error.

6. The image processing apparatus of claim 1 wherein the user interface includes a display in which a portion of the textual image is presented after undergoing OCR, said user interface being configured to receive user input correcting the first mischaracterized item and to recognize a user area portion of the display corresponding to the section of the textual image corrected by the user input.

7. The image processing apparatus of claim 1 wherein the consequential errors are corrected in a manner that is consistent with mischaracterized items previously corrected by the user.

8. The image processing apparatus of claim 1 further comprising a memory component for storing an electronic model of the image document, wherein the electronic model includes elements of the image document that are determined by each of the components, and further wherein the electronic model serves as input information that is supplied to each of the components by a previous component that processed the image document.

9. The image processing apparatus of claim 8 wherein the error correction component causes consequential errors arising in the text recognition component to be corrected by incrementally re-executing the text recognition component to process only elements that have been changed.

10. The image processing apparatus of claim 8 wherein the electronic model includes an attribute associated with each of the elements, wherein each of the attributes specifies a confidence level associated with the respective element with which the attribute is associated.

11. The image processing apparatus of claim 10 wherein the initial error arises in at least one of the elements included in the electronic model, wherein the correction component assigns a maximum value to the confidence level of one or more attributes associated with the at least one element after the initial error has been corrected.

12. A method for correcting a textual image document that has undergone optical character recognition (OCR), comprising:
receiving an electronic model of the image document after it has undergone an OCR process, the electronic model including elements of the image document that have been determined by each of a plurality of sequentially executed stages in the OCR process, wherein the electronic model serves as input information that is supplied to each of the stages by a previous stage that processed the image document;
presenting a graphical user interface to a user that receives user input data correcting a first mischaracterized item appearing in the document after undergoing OCR;
based at least in part on the user input data, causing a first of the stages of the OCR process that produced an initial error that gave rise to the first mischaracterized item to correct the initial error; and
causing stages of the OCR process subsequent to the first stage to correct consequential errors arising in their respective stages as a result of the initial error.

13. The method of claim 12 wherein presenting the graphical user interface includes requesting the user to categorize an error type to which the mischaracterized item belongs.

14. The method of claim 12 further comprising causing the first stage to correct other errors that give rise to other mischaracterized items of the same time as the first mischaracterized item.

15. The method of claim 12 wherein the user interface includes a menu of preselected error types from which the user selects as part of the user input data.

16. The method of claim 15 wherein the preselected error types include a plurality of error types selected from the group consisting of a text region error, a paragraph region error, a paragraph end error, a text line error, a word error and an image region error.

17. The method of claim 13 further comprising:
receiving user input data that includes selection of a first error type; and
based at least in part on the first error type, causing one or more selected components to be re-executed at least in part to correct the initial error.

18. A medium comprising instructions executable by a computing system, wherein the instructions configure the computing system to perform a method for correcting a textual image of a document that has undergone OCR, comprising:
receiving an electronic model of the image after it has undergone an OCR process, the electronic model including elements of the image that have been determined by each of a plurality of sequentially executed stages in the OCR process, wherein the electronic model serves as input information that is supplied to each of the stages by a previous stage that processed the image document;
based on user input data that corrects mischaracterized items in the image after it has undergone the OCR process, identifying a first stage of the OCR process that produced an initial error that gave rise to the first mischaracterized item;
correcting the initial error by re-executing the first stage of the OCR process at least in part; and
correcting consequential errors arising in stages of the OCR process subsequent to the first stage as a result of the initial error.

19. The medium of claim 18 wherein correcting the consequential errors comprises correcting the consequential errors arising in the stages of the OCR process subsequent to the first stage as a result of the initial error by re-executing at least in part the respective stages in which the respective consequential errors arise.

20. The medium of claim 19 wherein at least one of the respective stages that is re-executed is incrementally re-executed to only process elements of the electronic model that have changed as a result of correcting the initial error.
